(19) United States
(12) Patent Application Publication
(10) Pub. No.: US 2025/0007109 A1
(43) Pub. Date: Jan. 2, 2025

(54) Monitoring the Conductivity of an Electrical Connection Between the Cells of a Traction Battery of a Motor Vehicle

(71) Applicants: LISI Automotive, Grandvillars (FR); Université de Technologie Belfort Montbéliard, Sevenans (FR)

(72) Inventors: David Mercs, Belfort (FR); Amela Kusuran, Sochaux (FR); Sophie Costil, Offemont (FR); Geoffrey Darut, Auxelles Bas (FR)

(21) Appl. No.: 18/705,739

(22) PCT Filed: Nov. 2, 2022
(86) PCT No.: PCT/FR2022/052066

§ 371 Date: Apr. 29, 2024

(30) Foreign Application Priority Data
Nov. 5, 2021 (FR) 2111771

(51) Int. Cl. H01M 50/522; B05B 7/14; C23C 24/04; G01N 25/72; H01M 10/48; H01M 50/209; H01M 50/249; H01M 50/514

(52) U.S. Cl. CPC H01M 50/522; B05B 7/1404; C23C 24/04; G01N 25/72; H01M 10/482; H01M 10/486; H01M 50/209; H01M 50/249; H01M 50/514; H01M 2220/20

(57) ABSTRACT

An electrical connection (1) comprising two electrically conductive parts (11, 12) and an agglomerate (13) of electrically conductive material electrically connecting the two parts, the electrical connection comprising a temperature sensor (14) covered by the agglomerate and a means (15) for reading the temperature detected by the sensor (14).

The invention relates to electrical connections between two parts, and more particularly to the quality control of the connection between the cells of a battery.

Motor vehicles increasingly comprise an electric motor to move the vehicle. This electric motor is supplied by a so-called traction battery, also known as a power battery, presenting high capacity.

These power batteries generally comprise cells of lower capacity than the total capacity of the battery, which, when electrically connected together, allow the total capacity of the battery to be reached.

Good quality connections between the cells of a battery are essential to ensure good battery performance, increase its service life and limit maintenance operations during the life of the vehicle.

U.S. Pat. No. 10,640,876 B2 describes that the cells of a lithium ion battery with a liquid electrolyte are traditionally connected to an interconnection bar by means of bolts or ultrasonic welding. According to this document, however, these types of connection give rise to disadvantages such as poor fatigue strength and even poor conductance.

This document also indicates that, to avoid such disadvantages, these cells are connected to the interconnection bar by means of a thermal spraying of a material. However, the high temperature of the thermal spray would increase the amount of oxides, which are electrical insulators, embedded in the connection. Such oxides alter the electrical conductivity of the connection.

In order to alleviate these problems, the said document describes a connection between the cells and the interconnection bar using cold spraying of a metallic powder.

However, the quality of a battery cell connection fluctuates over time. Indeed, the conductivity of an electrical connection varies as a function of different parameters such as the materials chosen, the method chosen to make the electrical connection, the intensity of the current flowing through the connection, and even the temperature and humidity conditions in which the connection is located.

However, the above-mentioned document does not teach us about any means of controlling the quality of these connections.

The invention thus has as its object to propose a method for monitoring the conductivity of an optimized electrical connection, between two parts, over time.

First of all, an electrical connection is proposed, comprising two electrically conductive parts and an agglomerate of an electrically conductive material electrically connecting the two parts, the electrical connection comprising a temperature sensor covered by the agglomerate and a means of reading the temperature detected by the sensor.

Alternatively, the sensor is a thermocouple.

A second proposal is a battery or a module for battery comprising cells connected to one another by an electrical connection as previously described and comprising a means for monitoring the degradation of the battery or module over time based on analysis of the means for reading the electrical connection.

Alternatively, the cells are prismatic cells.

A third proposal is a motor vehicle comprising a battery such as previously described and comprising a battery degradation display means, for displaying the monitoring of the battery monitoring means.

Alternatively, the vehicle comprises an electric motor for moving the vehicle, the electric motor receiving its energy from the battery.

A fourth proposal is a method for monitoring an electrical connection inserted in a power supply circuit, the method comprising spraying an electrically conductive powder material onto two electrically conductive parts, the spraying forming, by agglomeration of the powder, an electrical connector connecting the two parts, the method comprising covering a temperature sensor with the powder forming the connector and reading the temperature detected by the sensor.

Various additional features may be provided, alone or in combination:
the method comprises texturing at least one surface of at least one of the two parts, spraying then being carried out on said surface, the grain dimensions of the powder being less than the texturing dimensions;
the temperature sensor is a thermocouple;
positioning of the sensor is carried out before the powder is sprayed;
positioning of the sensor is carried out while the powder is sprayed;
the powder spraying is carried out along a trajectory presenting, perpendicular to the direction of spraying, a slotted form;
the powder spraying comprises a first pass carried out along a first trajectory presenting, perpendicular to the direction of spraying, said slotted form and comprises a second pass carried out along a second trajectory presenting, perpendicular to the direction of spraying, a slotted form, said slotted form being arranged substantially perpendicular to the slotted form of the first trajectory;
the powder spray, is sprayed dynamically using cold gas;
the method comprises taking several temperature readings over time and storing these readings in order to allow the electrical connection to be monitored over time using a reference temperature.

A fifth proposal is an electrical connection obtained by a control method such as previously described.

A sixth proposal, for this purpose, is a method for monitoring the temperature of an electrical connection, the method comprising spraying a powder of an electrically conductive material onto two electrically conductive parts developing by agglomeration of the powder an electrical connection between the two parts.

The method thus allows to electrically connect the two parts or even to improve an existing electrical connection between the two parts.

The method also comprises covering a temperature sensor with the sprayed powder and analyzing the temperature detected by the sensor relative to a reference temperature.

Thus, the sensor is fixed to both parts, and the risk of the sensor coming loose is virtually nil. The reliability of the monitoring method is multiplied tenfold.

This temperature monitoring can be used to determine other quantities, the monitoring of which is necessary where required, such as, for example, the electrical conductivity between the two parts.

Various additional features can be provided, alone or in combination:
it comprises a texturing of at least one surface of at least one of the two parts, spraying then being carried out on said surface, the grain dimensions of the powder being less than the dimensions of the texturing: the powder thus being inserted into the texturing, improving conductivity and mechanical strength between the powder and the textured part(s) and the powder;
the temperature sensor is a thermocouple which is sufficiently resistant to powder spraying to form the agglomerate;
positioning of the sensor is carried out before the powder is sprayed;
positioning of the sensor is carried out while the powder is sprayed;
powder spraying is carried out along a trajectory presenting a slotted form perpendicular to the direction of spraying;
powder spraying comprises a first pass carried out along a first trajectory presenting, perpendicular to the direction of spraying, said slotted form and comprises a second pass carried out along a second trajectory presenting, perpendicular to the direction of spraying, a slotted form arranged substantially perpendicular to the slotted form of the first trajectory.

A seventh proposal is an electrical connection comprising two electrically conductive parts and an agglomerate of electrically conductive material electrically connecting the two parts, the electrical connection comprising a temperature sensor embedded in the agglomerate and means for reading and analyzing the temperature detected by the sensor relative to a reference temperature.

Alternatively, the sensor is a thermocouple.

An eighth proposal is a battery comprising cells connected to one another by an electrical connection as previously described and comprising means for monitoring battery degradation based on the analysis of the means for reading and analyzing the electrical connection.

Alternatively, the cells are prismatic cells.

A ninth proposal is a motor vehicle comprising a battery as previously described and comprising a battery degradation display means, displaying the monitoring of the battery monitoring means.

Alternatively, the vehicle comprises an electric motor for moving the vehicle, the electric motor receiving its energy from the battery.

The invention will be better understood, and other aims, features, details and advantages thereof will become clearer in the following explanatory description made with reference to the appended drawings given only as examples illustrating several embodiments of the invention and in which:

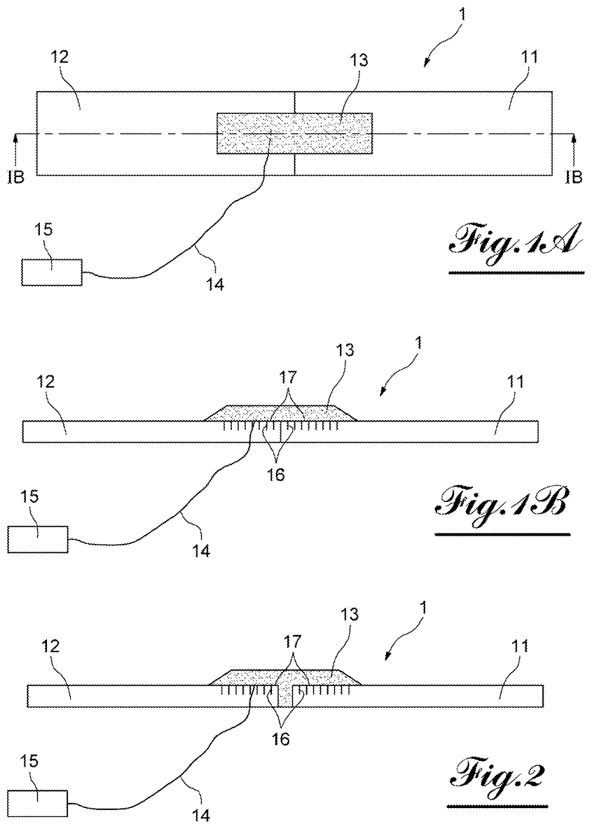

FIG. 1A is a schematic top view of a first embodiment of an electrical connection comprising a sensor integrated in a powder agglomerate:

FIG. 1B is a schematic cross-section view of the first embodiment of the electrical connection along the plane IB-IB of FIG. 1A:

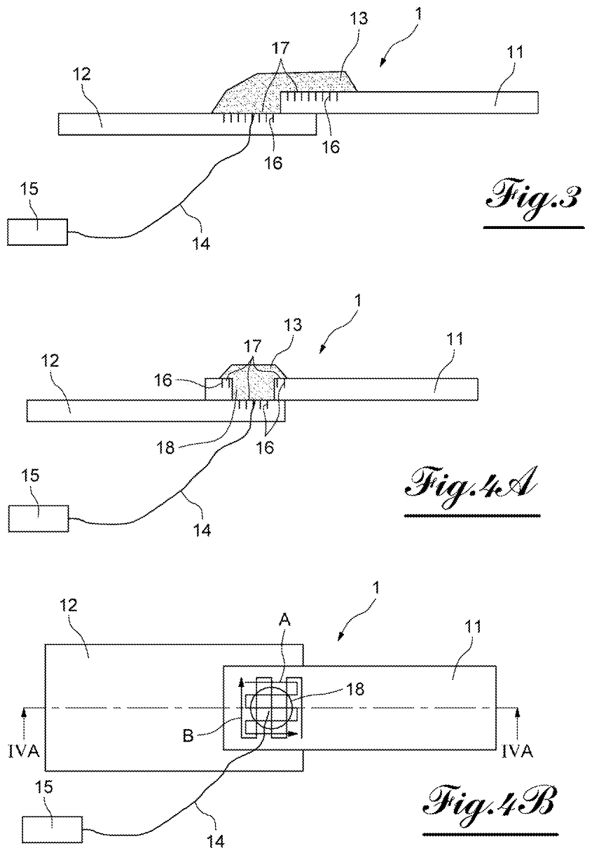

FIG. 2 is a schematic cross-section view of an electrical connection according to a second embodiment:

FIG. 3 is a schematic cross-section view of an electrical connection according to a third embodiment:

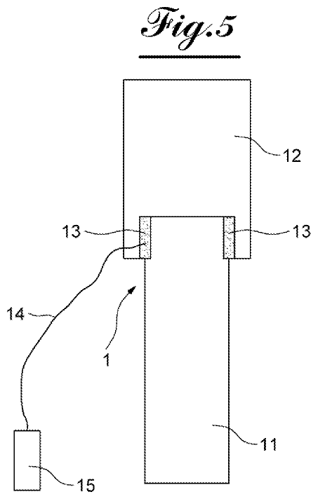

FIG. 4A is a schematic cross-section view of an electrical connection according to a fourth embodiment along the plane IVA-IVA of FIG. 4B:

FIG. 4B is a schematic top view of the fourth embodiment of the electrical connection in which a trajectory of a spray forming the agglomerate is shown:

FIG. 5 is a schematic top view of an electrical connection according to a fifth embodiment.

FIG. 1A shows a first embodiment of an electrical connection 1 comprising a first electrically conductive part 11, a second electrically conductive part 12 and an agglomerate 13 of a powder of an electrically conductive material.

The agglomerate 13 is in contact with the first part 11 and the second part 12 ensuring an electrical connection between the first part 11 and the second part 12. According to one embodiment, the electrical connection is also ensured by another part.

According to one embodiment, the agglomerate 13 is also attached to the first part 11 and the second part 12, ensuring mechanical continuity of the first part 11 and the second part 12 together. According to one embodiment, the mechanical fastening is also ensured by another part.

According to the embodiments shown, the agglomerate 13 presents the form of a bead, according to which the three dimensions of the agglomerate 13 are of the same order of magnitude.

The electrical connection 1 also comprises a sensor 14 integrated into the agglomerate 13. The sensor 14 is able to read the physical data allowing the conductivity of the electrical connection 1 to be measured or calculated.

According to one embodiment, the sensor 14 comprises a bimetallic junction constituting a thermocouple. The end of the thermocouple configured to sense temperature is integrated into the agglomerate 13 and the other end is outside the agglomerate 13.

According to one embodiment, the sensor 14 comprises an optical fiber.

The electrical connection 1 comprises a means 15 for reading the physical data recorded by the sensor 14. The reading means 15 is, for example, a computer or a tablet on board a motor vehicle.

When the sensor 14 is a thermocouple, the end of the thermocouple outside the agglomerate 13 allows to connect the means 15 for reading the temperature detected by the sensor 14.

According to one embodiment, not shown, the sensor 14 is connected to a wireless transmission means and the reading means 15 is connected to a wireless reception means. The link between the reading means 15 and the sensor 14 is thus wireless, for example by radio frequency identification (RFID) or by Bluetooth.

According to one embodiment, the transmitting means connected to the sensor 14 is integrated into the agglomerate 13.

The physical data captured, or other data obtained from this physical data, is, according to one embodiment, compared with a theoretical data in order to monitor the quality of the electrical connection 1. Thus, such an electrical connection 1 allows, for example, to issue an alert in the event of a drop in the quality of the electrical connection 1, in order to allow the electrical connection 1 to be maintained or replaced.

According to one embodiment, the sensor 14 is positioned against a surface of first part 11 and/or against a surface of second part 12. Thus, the reading of the data by the sensor 14 is unlikely to be altered by the agglomerate 13.

According to one embodiment, the dimension of the sensor is smaller than that of the bead. The size of the sensor is, for example, of the order of a millimeter, with no limitation as to form.

According to one embodiment, the first part 11 and/or the second part 12 comprises a recess or specific machining to facilitate the positioning of the sensor 14.

As shown in FIG. 1B, the electrical connection 1 comprises, below the agglomerate 13, a texturing 16 into which the agglomerate 13 penetrates.

The texturing 16 is carried out on a surface 17 on which the agglomerate 13 is positioned. According to various embodiments, this surface 17 belongs to the first part 11, to the second part 12 or even to the first part 11 and to the second part 12.

This texturing 16 increases the contact surface between the agglomerate 13 and the first part 11 and/or the second part 12.

This increase in contact area allows the electrical conductivity of the electrical connection 1 to be increased.

This texturing 16 also allows the mechanical strength of the connection between the first part 11 and the second part 12 by the agglomerate 13, to be increased.

According to one embodiment, the texturing 16 is carried out using a laser.

In the first embodiment, the first part 11 and the second part 12 are in frontal contact.

FIG. 2 shows the electrical connection 1 according to a second embodiment which has the same features as the first embodiment, with the exception that in this second embodiment the first part 11 and the second part 12 are not in direct contact with each other.

Thus, in this second embodiment, the agglomerate 13 is partially inserted between the first part 11 and the second part 12.

FIG. 3 shows a third embodiment of the electrical connection 1 which has the same features as the first embodiment with the exception that in this third embodiment the direct contact between the first part 11 and the second part 12 is obtained by overlapping the first part 11 and the second part 12 with each other.

FIG. 4A shows a fourth embodiment of the electrical connection 1 which has the same features as the third embodiment with the exception that in this fourth embodiment the first part 11 and/or the second part 12 is pierced at the overlap.

The piercing 18 reveals the surface 17 of the first part 11 or the second part 12 on which the agglomerate is positioned. In this fourth embodiment, the agglomerate 13 is formed at and around the piercing 18.

FIG. 4B shows the fourth embodiment from above, without showing the agglomerate 13. According to this embodiment, the piercing 18 is circular. According to other embodiments, the piercing 18 has a different form.

According to the embodiment shown, the diameter of the piercing is 8 mm. The thickness of the first part 11 and/or the second part 12 is 1 mm.

The agglomerate 13 is preferably, carried out by spraying a powder of a material that agglomerates on impact of this powder on the first part 11 and on the second part 12, then during impact with the powder that has already been sprayed and agglomerated.

This spraying is preferably carried out cold. This technique is known as Gas Dynamic Cold Spray (GDCS).

According to one embodiment, the powder spraying speed is supersonic, for example of the order of several hundred meters per second.

According to one embodiment, cold spraying is performed using a pressure of the order of 20 to 50 bar.

According to one embodiment, cold spraying is carried out at a temperature substantially below 350° C. In this way, oxidation of a sprayed metallic material powder is avoided, and better electrical conductivity of the connection is guaranteed.

The material constituting the powder is, for example, one or more aluminum alloys and/or one or more copper alloys.

FIG. 4B also schematically illustrates a trajectory taken to spray the powder forming the agglomerate 13.

According to the embodiment shown, the powder is sprayed in a first pass A along a trajectory, perpendicular to the spray, in a slotted form. The powder is then sprayed in a second pass B along a trajectory perpendicular to the spray, in a slotted form. The slots of the second pass B are substantially perpendicular to the slots of the first pass A.

According to one embodiment, the sensor 14 is first positioned against the first part 11 and/or against the second part 12. The texturing 16 is then carried out around the sensor 14. Then, the agglomerate 13 is formed.

According to one embodiment, the texturing 16 is carried out first. Then, the sensor 14 is positioned against the first part 11 and/or against the second part 12. Then, the agglomerate 13 is formed.

According to one embodiment, the texturing 16 is carried out first. Then, a first part of the agglomerate 13 is formed. Then, the sensor 14 is positioned against the first part of the agglomerate 13 formed. Then, a second part of the agglomerate 13 is formed on top of the first part of the agglomerate 13 already formed.

FIG. 5 shows a fifth embodiment of the electrical connection 1 which has the same features as the third embodiment, except that in this fifth embodiment the electrical connection 1 comprises two agglomerates 13. According to the embodiment shown, the agglomerates 13 are arranged on either side of the first part 11, at the contours of the first part 11 which are in contact with the second part 12.

According to one embodiment, the electrical connection 1 connects two cells of a motor vehicle power battery.

According to one embodiment, the electrical connections 1 connects the cells to an interconnection bar.

According to one embodiment, several cells connected to each other form a module, and several modules connected to each other form a power battery.

The power battery (or traction battery) is connected to an electric motor of the motor vehicle and is able to move the vehicle.

According to one embodiment, the cells are prismatic cells.

According to one embodiment, the battery is a lithium-ion battery.

Such an electrical connection 1 thus allows, by covering the sensor 14 with the agglomerate 13, a reading of the physical data detected by the sensor 14 and then analyzing this physical data.

According to one embodiment, this analysis can be carried out several times over time in order to monitor the evolution of the electrical connection as a function of time.

This analysis allows, by comparing the measured data with theoretical data (which may take the form of a curve of the physical data as a function of time), the quality of the electrical connection 1 to be determined and to decide on the maintenance to be carried out.

1. An electrical connection comprising two electrically conductive parts and an agglomerate of electrically conductive material electrically connecting the two parts, the electrical connection being characterized in that it comprises a temperature sensor covered by the agglomerate and a means for obtaining readings of the temperature detected by the temperature sensor.

2. The electrical connection according to claim 1, characterized in that the temperature sensor is a thermocouple.

3. A battery or a module for a battery comprising cells connected to one another by an electrical connection according to claim 1 and comprising a means for monitoring over time the degradation of the battery or module based on an analysis of the readings of the temperature detected by the temperature sensor.

4. The battery or the module for the battery according to claim 3, characterized in that the cells are prismatic cells.

5. A motor vehicle comprising a battery according to claim 3 and a battery degradation display means, configured to displaying the monitoring of the degradation of the battery or module.

6. The motor vehicle according to claim 5, comprising an electric motor for traction of the vehicle, the electric motor receiving its energy from the battery.

7. A method for controlling an electrical connection inserted in a power supply circuit, the method comprising spraying a powder of an electrically conductive material onto two electrically conductive parts, the spraying forming by agglomeration of the powder an electrical connector connecting the two parts, the method being characterized in that it comprises covering a temperature sensor with the powder forming the connector and reading the temperature detected by the sensor.

8. The control method according to claim 7, comprising a texturing of at least one surface of at least one of the two parts, the spraying then being carried out on the said surface, the grain dimensions of the powder being smaller than the dimensions of the texturing.

9. The control method according to claim 7, characterized in that the temperature sensor is a thermocouple.

10. The control method according to claim 7, characterized in that the positioning of the sensor is carried out before the powder is sprayed.

11. The control method according to claim 7, characterized in that the positioning of the sensor is carried out during spraying of the powder.

12. The control method according to claim 7, characterized in that the spraying of the powder is carried out along a trajectory presenting a slotted shape perpendicular to the direction of spraying.

13. The control method according to claim 12, characterized in that the spraying of the powder comprises a first pass (A) carried out along a first trajectory presenting, perpendicular to the direction of spraying, said slotted shape and comprises a second pass (B) carried out along a second trajectory presenting, perpendicular to the direction of spraying, a slotted shape arranged substantially perpendicular to the slotted shape of the first trajectory.

14. The control method according to claim 7, characterized in that the spraying of the powder is a dynamic cold gas spraying.

15. The control method according to claim 7, further comprising taking several temperature readings over time and storing these readings in order to allow the electrical connection to be monitored over time using a reference temperature.

16. An electrical connection obtained by a control method according to claim 7.
